(19) United States
(12) Patent Application Publication
(10) Pub. No.: US 2008/0029058 A1
(43) Pub. Date: Feb. 7, 2008

(54) Control arrangement for activating and deactivating cylinders of a multicylinder engine

(76) Inventors: Markus Duesmann, Munchen (DE); Thomas Stolk, Kirchheim (DE); Alexander Von Gaisberg-Helfenberg, Beilstein (DE)

Correspondence Address: KLAUS J. BACH, 4407 TWIN OAKS DRIVE, MURRYSVILLE, PA, 15668, US

(21) Appl. No.: 11/731,782

(22) Filed: Mar. 30, 2007

Related U.S. Application Data
(63) Continuation-in-part of application No. PCT/EP05/10618, filed on Oct. 1, 2005.

(30) Foreign Application Priority Data
Oct. 2, 2004 (DE) 10 2004 048 143.1

(51) Int. Cl. F02D 17/02

(52) U.S. Cl. 123/198 F

(57) ABSTRACT

In a control arrangement with a control unit for activating and deactivating cylinders of a multi-cyliner internal combustion engine including throttle units assigned to the various cylinders of the internal combustion engine, the control unit provides for opening and/or closing of the throttle units assigned to the cylinder during the switching process in accordance with a predetermined timing function.

This is a Continuation-In-Part Application of pending International Patent Application PCT/EP2005/010618 filed Oct. 1, 2005 and claiming the priority of German Patent Application 10 2004 048 143.1 filed Oct. 2, 2004.

### BACKGROUND OF THE INVENTION

The invention relates to a device having a control unit for activating a plurality of throttle units assigned each to a cylinder of a multi-cylinder internal combustion engine and to a method for controlling the throttle units and activating and deactivating those cylinders.

DE 101 48 347 A1 discloses a method for activating a plurality of throttle units. The throttle units are each assigned to a cylinder of an internal combustion engine and are suitable for activating or deactivating a group of cylinders of the internal combustion engine in an activation or deactivation process. By means of the throttle units, the control unit influences the torque generated by the cylinders. During the activation process or deactivation process, the control unit controls the group of cylinders of the internal combustion engine which are complementary, to the group of cylinders in such a way that an overall torque of the internal combustion engine remains constant, with the torque generated by the group of cylinders being increased or decreased to a setpoint value. A signal for starting the switching process is generated by a central control unit of a motor vehicle which comprises the internal combustion engine. In the process, the group of cylinders is deactivated, in order to reduce fuel consumption, when the internal combustion engine is running under partial load.

The invention is based in particular on the object of providing a device of the generic type by means of which a particularly comfortable or jolt-free activation process and/or deactivation process of at least one cylinder of the internal combustion engine can be implemented.

### SUMMARY OF THE INVENTION

In a control arrangement with a control unit for activating and deactivating cylinders of a multi-cyliner internal combustion engine including throttle units assigned to the various cylinders of the internal combustion engine, the control unit provides for opening and/or closing of the throttle units assigned to the cylinder during the switching process in accordance with a predetermined timing function.

The invention is based on a device having a control unit for activating at least one throttle unit which is assigned to a cylinder of an internal combustion engine having a plurality of cylinders and by means of which the cylinder can be activated and/or deactivated in a switching process according to a predetermined timing function in such a way that a comfortable switching process is achieved which cannot be perceived as a jolt by a driver of the motor vehicle. In addition, control oscillations can be effectively avoided. An adaptable timing function permits advantageously flexible adaptation of the control unit to a type of a motor vehicle which comprises the internal combustion engine and/or to a specific field of use of the motor vehicle.

Any unit which appears appropriate to a person skilled in the art and is suitable for influencing a torque generated by the cylinder will be referred to as a throttle unit. In this context, the throttle unit can be configured as a throttle valve, throttle flap or as a unit for determining a valve stroke of an inlet valve or outlet valve of the cylinder which is controlled by means of a camshaft. A device for electromagnetically controlling the valve stroke of an inlet valve or outlet valve will also be referred to as a throttle unit in this context. The internal combustion engine can be in principle a piston engine which has a plurality of cylinders and appears appropriate to a person skilled in the art, in particular a diesel engine or spark ignition engine. A genuine subset of the total number of cylinders of the internal combustion engine will be referred to as a group of cylinders. A switching process which, over a time period lasting for a plurality of working cycles, places the cylinder in a state in which the cylinder does not make any contribution to generating the torque of the internal combustion engine will be referred to as deactivation of the cylinder.

The timing function can be permanently predefined or can be adjustable mechanically by means of the control unit or have a selectable software parameter which can be set and stored during installation of the control unit.

In a refinement of the invention the timing function is continuous. As a result, a particularly jolt-free switching process can be obtained. However, in principle, refinements of the invention in which the timing function has a small-stage incremental profile are also conceivable. This can be appropriate, in particular if the throttle unit is only discontinuously adjustable.

Uncontrolled oscillations as a result of dynamics of a charge of the cylinder and/or dynamics of the throttle unit can be avoided if the timing function can be differentiated continuously.

Particularly large fuel saving potentials can result from the activation and deactivation of a group of cylinders if the internal combustion engine has at least eight cylinders. It is similarly advantageous to use the solution according to the invention in conjunction with internal combustion engines with 12 or 16 cylinders.

In this context, rough running of the internal combustion engine can be avoided if at least four cylinders can be deactivated. However, in principle, refinements of the invention in which two or some other number of cylinders are combined to form a deactivatable group are also conceivable.

A device which can be adapted flexibly to an operating situation can be obtained if the timing function is determined by at least one operating parameter. In this context, the timing function can contain in particular a timing constant which is dependent on the operating parameter. The operating parameter used can be, for example, a characteristic variable for the driving behavior of the driver, a rate of change of an accelerator pedal angle, a gearbox transmission ratio or some other operational variable which appears appropriate to a person skilled in the art. In this context, advantageous tolerance compensation can be achieved if the operational variable is determined by an activation or deactivation process which precedes the current switching process.

In addition, it is proposed that the control unit comprises a switching element which triggers the switching process if an operating point of the internal combustion engine crosses a characteristic curve in an engine characteristic diagram. In this context, the switching element can be implemented particularly easily and cost-effectively as a checkbit of a computing unit of the control unit. The control unit can be embodied in one piece or in multiple pieces with a central control unit of the internal combustion engine. In addition, the control unit could be integrated into a central control unit of a motor vehicle which comprises the internal combustion engine, and could communicate, for example via a CAN bus, with the internal combustion engine control.

Flexible adaptation of the characteristic curve to the field of use of the internal combustion engine can be made possible if the control unit comprises a memory unit for storing the characteristic curve.

If the control unit comprises a memory unit for storing an adjustable parameter of the timing function, in particular a timing constant, which describes a duration of the switching process, a device which can be used in a flexible way can be obtained.

The device is distinguished by the fact that a first characteristic curve is assigned to a deactivation process of the cylinder, and that a second characteristic curve is assigned to an activation process of the cylinder, non-smooth jumping to and fro and possibly associated loss of comfort can be avoided, specifically in particular if a hysteresis region is provided between the first characteristic curve and the second characteristic curve or if a region of the engine characteristic diagram in which the deactivatable cylinder is deactivated after a deactivation process overlaps with a region of the engine characteristic diagram in which the deactivatable cylinder is activated after an activation process.

In addition, the invention is based on a method for activating a throttle unit which is assigned to a cylinder of an internal combustion engine and by means of which the cylinder can be activated and/or deactivated in a switching process.

It is proposed that the throttle unit which is assigned to the deactivatable cylinder be opened and/or closed during the switching process according to a predetermined timing function.

The invention will become more readily apparent from the following description of an exemplary embodiment of the invention on the basis of the accompanying drawings:

### BRIEF DESCRIPTION OF THE DRAWINGS

FIG. 1 is a schematic illustration of an internal combustion engine having a control unit,

FIG. 2 is a flowchart of a program which is implemented by the control unit,

FIG. 3 is an engine characteristic diagram with characteristic curves,

FIG. 4 shows a time profile of the torque of a first group of cylinders and of the torque of a second group of cylinders during a deactivation process, and

FIG. 5 shows a time profile of the torque of a first group of cylinders and of the torque of a second group of cylinders during an activation process.

### DESCRIPTION OF A PREFERRED EMBODIMENT OF THE INVENTION

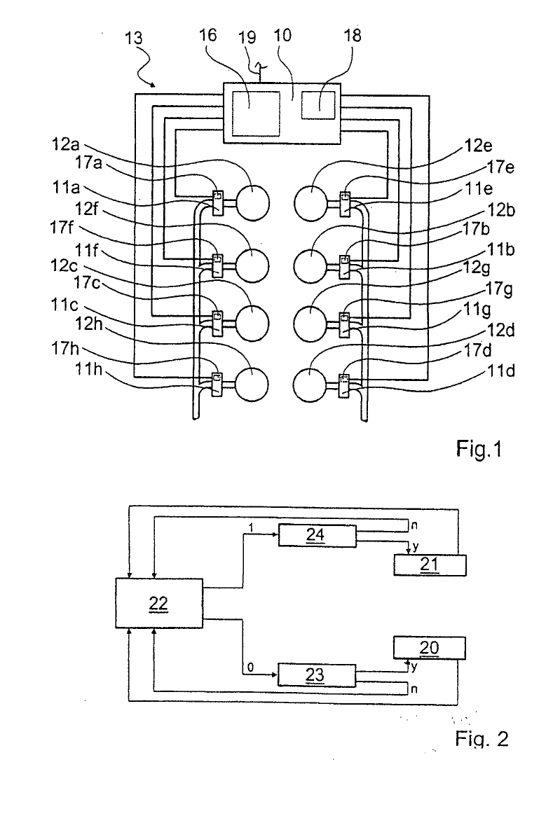

FIG. 1 shows an internal combustion engine 13 which is embodied as a spark ignition engine with eight cylinders 12a-12h in a schematic illustration. Each of the cylinders 12a-12h has known inlet and outlet valves which are not illustrated explicitly here and which are provided for charging the cylinder 12a-12h and discharging exhaust gas. In principle, the solution according to the invention can be used in all conceivable internal combustion engines having a plurality of cylinders, in particular even in diesel engines or in engines with turbochargers or exhaust gas recirculation. The inlet and outlet valves are activated by a camshaft (not illustrated here).

Each of the eight cylinders 12a-12h is assigned a throttle unit 11a-11h by means of which a charge supply to the respective cylinder 12a-12h can be throttled and completely interrupted. The throttle units 11a-11h each comprise an electromagnetic activation element 17a-17h. The activation elements 17a-17h are connected to a control unit 10 of the internal combustion engine 13 via control lines. The control unit 10 is embodied as a programmable computing unit and comprises a memory unit 16 and a switching element 18. In addition, the control unit 10 communicates via a CAN bus 19 with further control units of a motor vehicle which comprises the internal combustion engine 13, and can read out, via the CAN bus 19, all the operational variables collected in the motor vehicle, and can make them available to form a characteristic variable representing a current activation state of the internal combustion engine 13 for the further control units.

In addition to electromagnetic activation elements 17a-17h, hydraulic and/or mechanical activation elements can also be used. The throttle elements may also be embodied as single units with charge control flaps or with inlet valves of the cylinders 12a-12h. In this context, the throttle elements can be embodied, for example, as camshaft adjustors or as mechanisms for mechanically setting a valve stroke.

By means of the control lines the control unit 10 can continuously adjust the throttle units 11a-11h independently of one another, and, in particular, open and close them. In particular, the control unit 10 is suitable for closing any desired group of throttle units 11a-11h independently.

A program which opens or closes a group of four cylinders 12a-12d in response to a switching signal is implemented in the control unit 10. In this context, the control unit 10 generates the switching signal automatically as a function of a rotational speed and of a load of the internal combustion engine 13 in a way which is described in more detail below.

The program triggers switching processes 20, 21 between a first operating state in which the group of cylinders 12a-12d is activated, and a second operating state in which the group of cylinders 12a-12d is deactivated and in which the throttle units 11a-11h are closed. The value 0 of a checkbit which is stored in the memory unit 16 is assigned to the first operating state, and the value 1 is assigned to the second operating state.

The program runs through an interrogation cycle which is illustrated in FIG. 2. In a first step 22, the control unit 10 interrogates the checkbit.

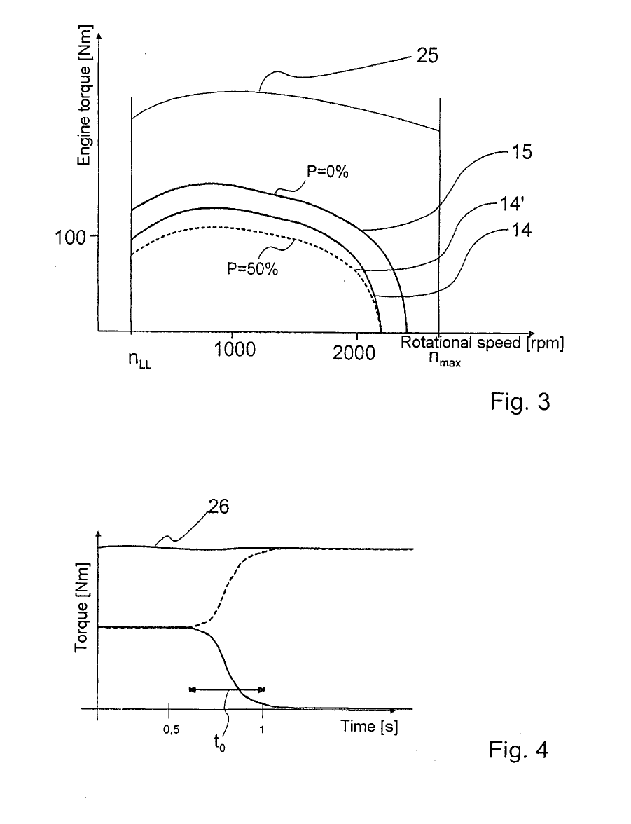

If the control unit 10 finds the value 0, the first operating mode is present, and the control unit 10 interrogates, in an interrogation step 23, whether a current load of the internal combustion engine 13 whose value the control unit 10 reads out via the CAN bus 19 is less than a critical value which is stored in the form of a characteristic curve 14 (FIG. 3) in the memory unit 16 of the control unit 10. The characteristic curve 14 depends on a rotational speed of the internal combustion engine 13 and on a further operating parameter P, specifically on an accelerator pedal position. When the accelerator pedal is engaged further, the characteristic curve 14 in the engine characteristic diagram (FIG. 3) moves downward. In FIG. 3, a characteristic curve 14 is shown by way of example for P=0%, and a characteristic curve 14′ for P=50%. By changing the program it is possible for any variable which appears appropriate to a person skilled in the art to be used as the characteristic variable P. In particular, a characteristic variable for sporty driving behavior can advantageously be used.

An operating point of the internal combustion engine 13 is determined as a point in the two-dimensional engine characteristic diagram of the internal combustion engine 13 and is always below a type-dependent characteristic curve 25—which describes a maximum power value of the internal combustion engine 13—in FIG. 3. The characteristic curve 25 delimits the engine characteristic diagram, together with an idling rotational speed n_{LL} and a maximum rotational speed nₘₐₓ.

If the control unit 10 finds, in the interrogation step 23, an operating point which lies below the characteristic curve 14 in FIG. 3, it outputs a signal to the switching element 18 which triggers a deactivation process 20 in order to save fuel in the following operation. The operating point has then exceeded the characteristic curve 14 in the preceding cycle of the program. In this context, the control unit 10 closes the throttle units 11a-11d by means of the activation elements 17a-17d according to a predefined timing function providing for a continuously variable rate, and said control unit 10 at the same time increases the degree of opening of the throttle units 11e-11h. In the process, the torques which are generated by the cylinders 12a-12h are changed in a way which is proportional to the degree of opening and, respectively, closing of the throttle units 11a-11h, specifically in such a way that the sum of the torque generated by cylinders of the internal combustion engine 13 always corresponds to a request value 26 determined by the characteristic variable P (FIG. 4). Refinements of the invention in which a dependence between the torque and the degree of opening of the throttle units 11a-11h is stored in a characteristic diagram stored in the memory unit 16 are also conceivable. After the switching process 20 has been terminated, the control unit 10 sets the checkbit to the value 1.

If the control unit 10 finds the value 1 in the step 22, the second operating mode is present and the control unit 10 interrogates, in an interrogation step 24, whether a current load of the internal combustion engine 13 whose value the control unit 10 reads out via the CAN bus 19 is greater than a second critical value which is stored in the form of a characteristic curve 15 in the memory unit 16 of the control unit 10. The characteristic curve 15 depends on the rotational speed of the internal combustion engine 13 and on the operating parameter P.

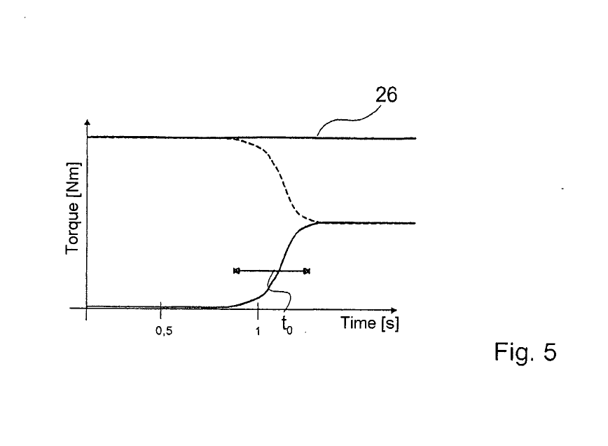

If the operating point is above the characteristic curve 15, the control unit 10 triggers a switching process 21 in which it opens the throttle units 11a-11d of the group of cylinders 12a-12d according to a predetermined timing function using the activation elements 17a-17h, and at the same time reduces the degree of opening of the complementary throttle units 11e-11h in order to implement an overall torque of the internal combustion engine 13 which corresponds to the request value 26 (FIG. 5). The operating point must then have crossed the characteristic curve 15 in the preceding cycle of the program.

After the switching process 21 has been terminated, the control unit 10 sets the checkbit to the value 0.

During the switching processes 20, 21, the cyclical sequence of the program remains interrupted so that the switching processes 20, 21 are always ended according to the timing function which has been set.

A torque which is described by the characteristic curve 14 is smaller in the entire engine characteristic diagram than a torque which is described by the characteristic curve 15 so that rapid switching between the two operating modes is avoided and a hysteresis is established at the transitions between the operating modes.

In principle, any function which appears appropriate to a person skilled in the art and which interpolates between a fraction of the request value 26 and the value 0 can be used as the timing function. An example of the timing function for the torque profile of the group of cylinders 12a-12d during the deactivation process is
A/4·(cos(πₜ/t₀)+1),
while the complementary group of cylinders 12e-12h is controlled according to the timing function
A/4·(3-cos (πt/t₀)).
Here, the time extends between t=0 and t=t₀, where t₀ is an adjustable time constant which is stored in the memory unit 16 and which can also depend on an external characteristic variable. The time constant t₀ is set when the control unit is installed. A is the request value 26 which is dependent on the characteristic variable P.

The timing function can be set by virtue of the fact that the parameter t₀ can be selected. Refinements of the invention in which the timing function depends on a plurality of adjustable parameters are also conceivable.

What is claimed is:

1. A control arrangement including a control unit (10) for activating and deactivating cylinders of a multi-cylinder-internal combustion engine having a throttle unit (11a-11h) assigned to each cylinder (12a-12h) of the internal combustion engine (13) for activating or, respectively, deactivating the respective cylinder (12a-12d) in a switching process, the control unit (10) being adapted to open or, respectively, close the throttle unit (11a-11d) assigned to the deactivatable cylinder (12a-12d) during the switching process (20, 21) according to a predetermined timing function.

2. The device as claimed in claim 1, wherein the timing function is a continuous function.

3. The device as claimed in claim 2, wherein the timing function is continuously variable.

4. The device as claimed in claim 1, wherein each of the throttle units (11a-11h) has an activation element (17a-17h) by means of which the respective throttle unit (11a-11h) can be activated independently.

5. The device as claimed in claim 1, wherein the internal combustion engine (13) comprises at least eight cylinders (12a-12h).

6. The device as claimed in claim 1, wherein at least four cylinders (12a-12d) are deactivable.

7. The device as claimed in claim 1, wherein the timing function is dependent on at least one operating parameter (P).

8. The device as claimed in claim 1, wherein the control unit (10) includes a switching element (18) which triggers the switching process when an operating point of the internal combustion engine (13) crosses a characteristic curve (14, 15) in an engine characteristic diagram.

9. The device as claimed in claim 8, wherein the control unit includes a memory unit (16) for storing the characteristic curve (14, 15).

10. The device as claimed in claim 9, wherein the memory unit (16) is adapted to store an adjustable parameter (t₀) of the timing function.

11. The device as claimed in claim 8, wherein a first characteristic curve (14, 14′) is assigned to a deactivation process of the deactivatable cylinders (12a-12d), and a second characteristic curve (15) is assigned to an activation process of the deactivatable cylinders (12a-12d).

12. A method for activating a throttle unit (11a-11h) which is assigned to a cylinder (12a-12h) of an internal combustion engine (13) and by means of which at least one cylinder (12a-12d) can be activated and deactivated in a switching process (20, 21), method comprising the steps of opening and, respectively, closing the throttle unit (11a-11d) which is assigned to the deactivatable cylinder (12a-12d) during the switching process (20, 21) according to a predetermined timing function.
